(19) United States
(12) Patent Application Publication
(10) Pub. No.: US 2021/0262674 A1
(43) Pub. Date: Aug. 26, 2021

(54) OVEN APPLIANCE FOR HIGH-HEAT COOKING OPERATIONS

(71) Applicant: Haier US Appliance Solutions, Inc., Wilmington, DE (US)

(72) Inventors: Eric Scott Johnson, Louisville, KY (US); Hans Juergen Paller, Louisville, KY (US)

(21) Appl. No.: 16/795,830

(22) Filed: Feb. 20, 2020

(51) Int. Cl. F24C 15/32; F24C 15/34; F24C 15/02; F27D 21/00; F24C 15/00

(52) U.S. Cl. CPC F24C 15/32; F24C 15/34; F27D 2019/0003; F27D 21/0014; F24C 15/006; F24C 15/02

(57) ABSTRACT

An oven appliance, as provided herein, may include a cabinet, a plurality of chamber walls, a cooking surface, and a bottom heating element. The chamber walls are mounted within the cabinet and define an oven chamber. The chamber walls may include a back wall, a top wall, a first side wall, a second side wall, and a bottom wall. The cooking surface may be defined in the oven chamber between the bottom wall and the top wall. The bottom heating element may be mounted above the bottom wall to heat the cooking surface within the oven chamber. The chamber walls may define a cavity vent and an exhaust opening. The cavity vent may be defined upstream from the oven chamber below the bottom heating element. The exhaust outlet may be defined downstream from the oven chamber and proximal to the top wall to direct air from the cabinet.

### FIELD OF THE INVENTION

The present subject matter relates generally to oven appliances, and more particularly, to heating and ventilation assemblies of an oven appliance.

### BACKGROUND OF THE INVENTION

Conventional residential and commercial oven appliances generally include a cabinet that includes a cooking chamber for receipt of food items for cooking. Multiple gas or electric heating elements are positioned within the cabinet for heating the cooking chamber to cook food items located therein. The heating elements can include, for example, a bake heating assembly positioned at a bottom of the cooking chamber and a separate broiler heating assembly positioned at a top of the cooking chamber.

Typically, food or utensils for cooking are placed on wire racks within the cooking chamber and above the bake heating assembly. In some instances, protective or radiant plates are positioned over the bake heating assembly to protect the bake heating assembly or assist in evenly distributing heat across the bottom of the cooking chamber. Oftentimes, the wire racks are at least mounted well above a bake heating assembly to ensure the bake heating assembly is not damaged or a user does not accidentally contact the bake heating assembly. When the bake heating assembly is activated, heat from the bake heating assembly is thus forced to rise through an air gap, and any other intermediate elements, between the bake heating assembly and the wire rack before the utensil on the wire rack can be heated. Heat is within the cooking chamber is relatively diffuse, and the temperature is generally consistent about the item or items on the rack.

Although these conventional configurations are useful for many types of foods, there are certain disadvantages. For instance, certain food items benefit from very high, localized (i.e., non-diffuse) heat. Oftentimes, stone or specialized high-heat pans are used for trapping heat against the bottom of flat-breads or pizza. Such pans may be difficult to preheat or maintain a specific temperature desired by the user. Although placing a pan closer to a heating element may help heat the pan faster or to a higher temperature, this may cause the pan or trapped heat to damage portions of the oven appliance. Moreover, trapping or localizing heat too much may lead to burning certain portions of a food item, without sufficiently cooking the rest. Additionally or alternatively, problems may arise from attempts to heat one region or article to a relatively high temperature. For instance, the rest of the oven chamber may become excessively hot. Opening an oven door, in particular, may quickly release such excessive heat, which can be uncomfortable for a nearby user. Furthermore, damage may be caused to certain portions of the appliance.

Accordingly, it would be advantageous to provide an oven appliance capable of safely generating high heat on a specific cooking surface within the oven appliance without unduly trapping heat or causing damage to the oven appliance or cooking surface.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, an oven appliance is provided. The oven appliance may include a cabinet, a plurality of chamber walls, a cooking surface, and a bottom heating element. The plurality of chamber walls are mounted within the cabinet. The plurality of chamber walls may define an oven chamber. The plurality of chamber walls may include a back wall, a top wall, a first side wall, a second side wall, and a bottom wall. The cooking surface may be defined in the oven chamber between the bottom wall and the top wall. The bottom heating element may be mounted above the bottom wall to heat the cooking surface within the oven chamber. The chamber walls may define a cavity vent and an exhaust opening. The cavity vent may be defined upstream from the oven chamber below the bottom heating element. The exhaust outlet may be defined downstream from the oven chamber and proximal to the top wall to direct air from the cabinet.

In another exemplary aspect of the present disclosure, an oven appliance is provided. The oven appliance may include a cabinet, a plurality of chamber walls, a cooking surface, a bottom heating element, and a top heating element. The plurality of chamber walls are mounted within the cabinet. The plurality of chamber walls may define an oven chamber. The plurality of chamber walls may include a back wall, a top wall, a first side wall, a second side wall, and a bottom wall. The cooking surface may be defined in the oven chamber between the bottom wall and the top wall. The bottom heating element may be mounted above the bottom wall to heat the cooking surface within the oven chamber. The a top heating element may be mounted above the bottom heating element to heat the oven chamber. The chamber walls may define a cavity vent and an exhaust opening. The cavity vent may be defined upstream from the oven chamber below the bottom heating element. The exhaust outlet may be defined downstream from the oven chamber and spaced apart from the top heating element to direct air from the cabinet.

In yet another exemplary aspect of the present disclosure, an oven appliance is provided. The oven appliance may include a cabinet, a plurality of chamber walls, a cooking surface, a bottom heating element, and a bottom insulator plate. The plurality of chamber walls are mounted within the cabinet. The plurality of chamber walls may define an oven chamber. The plurality of chamber walls may include a back wall, a top wall, a first side wall, a second side wall, and a bottom wall. The cooking surface may be defined in the oven chamber between the bottom wall and the top wall. The bottom heating element may be mounted above the bottom wall to heat the cooking surface within the oven chamber. The bottom insulator plate may be disposed between the bottom heating element and the bottom wall along a vertical direction. The chamber walls may define a cavity vent and an exhaust opening. The cavity vent may be defined upstream from the oven chamber. The exhaust outlet may be defined downstream from the oven chamber and proximal to the top wall to direct air from the cabinet.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides an elevation view of an oven appliance according to exemplary embodiments of the present disclosure.

FIG. 2 provides a perspective view of an upper cooking chamber of the exemplary oven appliance of FIG. 1.

FIG. 3 provides a perspective view of the upper cooking chamber of the exemplary oven appliance of FIG. 1, wherein certain elements have been removed for clarity.

FIG. 4 provides a front, perspective, sectional view of a portion of the exemplary oven appliance of FIG. 1.

FIG. 5 provides a side sectional view of the upper cooking chamber of the exemplary oven appliance of FIG. 1.

FIG. 6 provides a front, schematic elevation view of the upper cooking chamber of the exemplary oven appliance of FIG. 1.

FIG. 7 provides a side, schematic elevation view of the upper cooking chamber of the exemplary oven appliance of FIG. 1.

FIG. 8 provides a bottom, perspective view of the upper cooking chamber of the exemplary oven appliance of FIG. 1, wherein certain elements have been removed for clarity.

FIG. 9 provides a side, perspective, sectional view of a portion of the exemplary oven appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

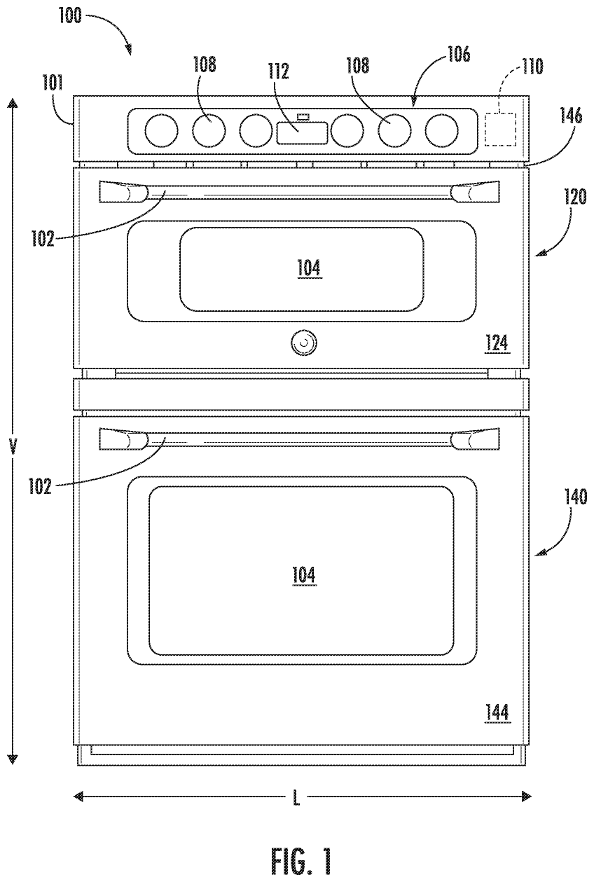

Referring now to the drawings, FIG. 1 illustrates an exemplary embodiment of a double oven appliance 10 according to the present disclosure.

Although aspects of the present subject matter are described herein in the context of a double oven appliance 100, it should be appreciated that oven appliance 100 is provided by way of example only. Other oven or range appliances having different configurations, different appearances, or different features may also be utilized with the present subject matter as well (e.g., single ovens, electric cooktop ovens, induction cooktops ovens, etc.).

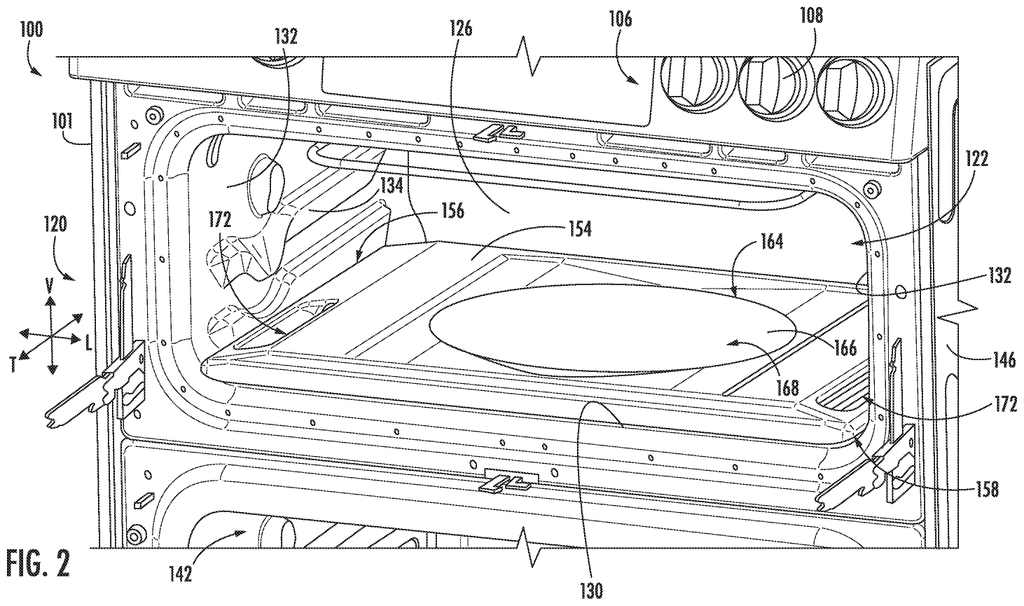

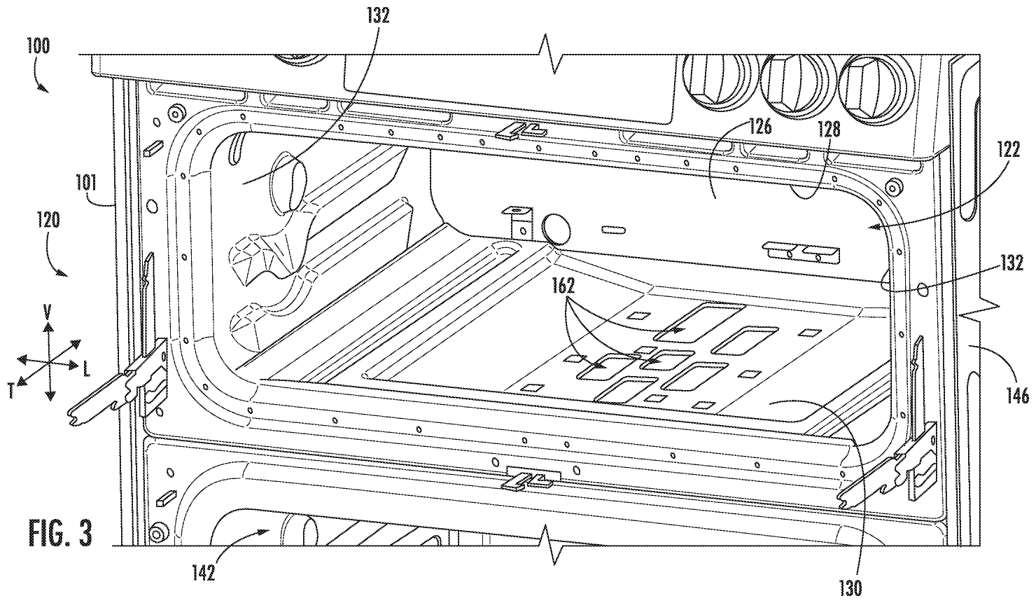

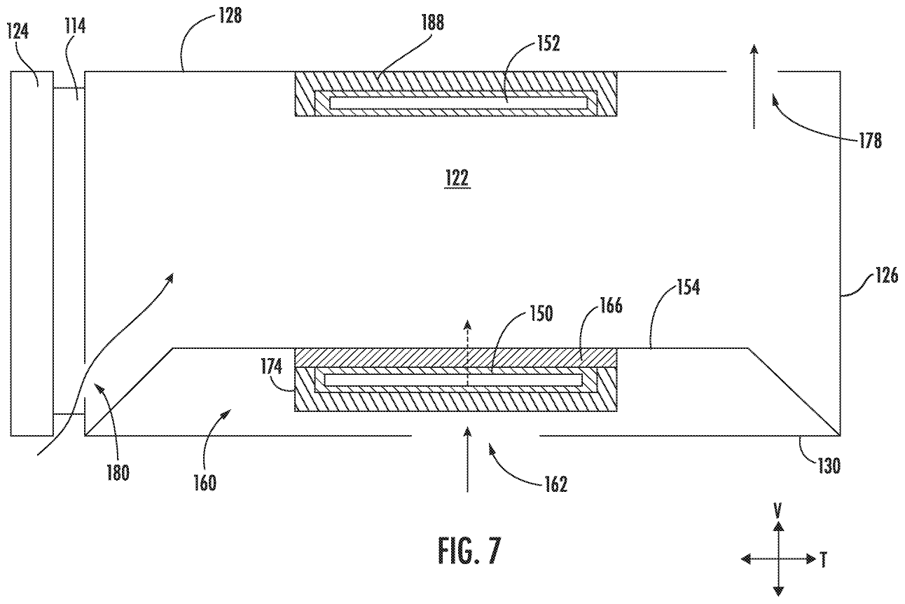

Generally, oven appliance 100 has a cabinet 101 defines a vertical direction V, a longitudinal direction L and a transverse direction T. The vertical, longitudinal and transverse directions are mutually perpendicular and form an orthogonal direction system. Double oven appliance 100 includes an upper oven 120 and a lower oven 140 positioned below upper oven 120 along the vertical direction V. Upper and lower ovens 120 and 140 include oven or cooking chambers 122 and 142, respectively, configured for the receipt of one or more food items to be cooked. Double oven appliance 100 includes an upper door 124 and a lower door 144 in order to permit selective access to cooking chambers 122 and 142, respectively. Handles 102 are mounted to upper and lower doors 124 and 144 to assist a user with opening and closing doors 124 and 144 in order to access cooking chambers 122 and 142. As an example, a user can pull on handle 102 mounted to upper door 124 to open or close upper door 124 and access cooking chamber 122. Glass window panes 104 provide for viewing the contents of cooking chambers 122 and 142 when doors 124, 144 are closed and also assist with insulating cooking chambers 122 and 142. Optionally, a seal or gasket (e.g., gasket 114—FIG. 7) extends between each door 124, 144 and cabinet 102 (e.g., when the corresponding door 124 or 144 is in the closed position). The gasket 114 may assist with maintaining heat and cooking fumes within the corresponding cooking chamber 122 or 142 when the door 124 or 144 is in the closed position. As illustrated further in FIGS. 2 and 3, heating elements, such as electric resistance heating elements, gas burners, microwave elements, etc., are positioned within upper and lower oven 120 and 140.

A control panel 106 of double oven appliance 100 provides selections for user manipulation of the operation of double oven appliance 100. For example, a user can touch control panel 106 to trigger one of user inputs 108. In response to user manipulation of user inputs 108, various components of the double oven appliance 100 can be operated. Control panel 106 may also include a display 112, such as a digital display, operable to display various parameters (e.g., temperature, time, cooking cycle, etc.) of the double oven appliance 100.

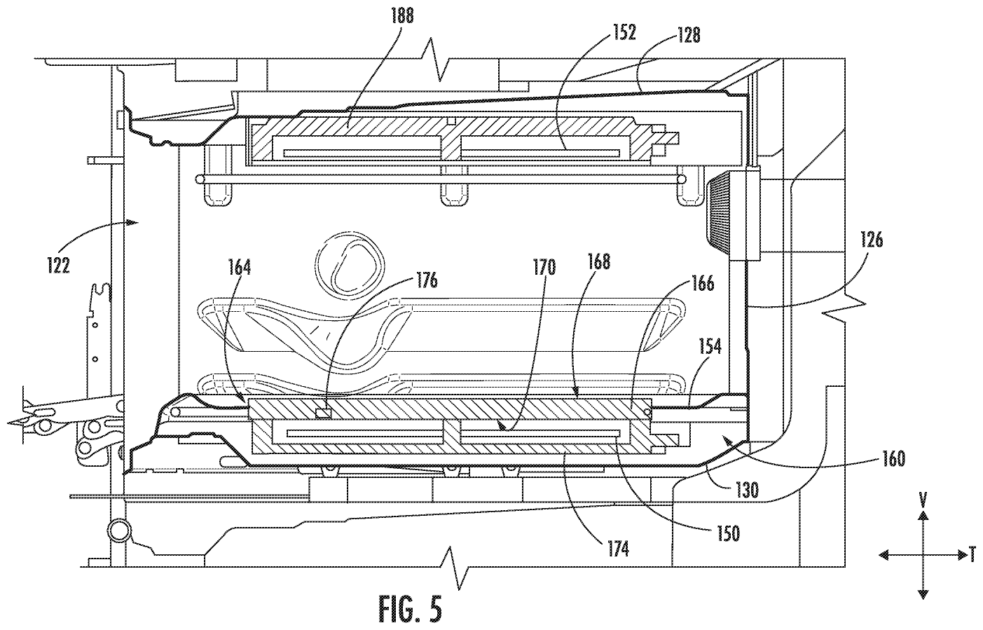

Generally, oven appliance 100 may include a controller 110 in operative communication (e.g., operably coupled via a wired or wireless channel) with control panel 106. Control panel 106 of oven appliance 100 may be in communication with controller 110 via, for example, one or more signal lines or shared communication busses, and signals generated in controller 110 operate oven appliance 100 in response to user input via user input devices 108. Input/Output (“I/O”) signals may be routed between controller 110 and various operational components of oven appliance 100 such that operation of oven appliance 100 can be regulated by controller 110. In addition, controller 110 may also be communication with one or more sensors, such as temperature sensor 176 (FIG. 5), such as a thermistor or thermocouple, which may be used to measure temperature inside upper cooking chamber 122 and provide such measurements to the controller 110. Although temperature sensor 176 is illustrated within an enclosed region 160 proximate to bottom heating element 150, it should be appreciated that other sensor types, positions, and configurations may be used according to alternative embodiments.

Controller 110 is a “processing device” or “controller” and may be embodied as described herein. Controller 110 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 110 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 110 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

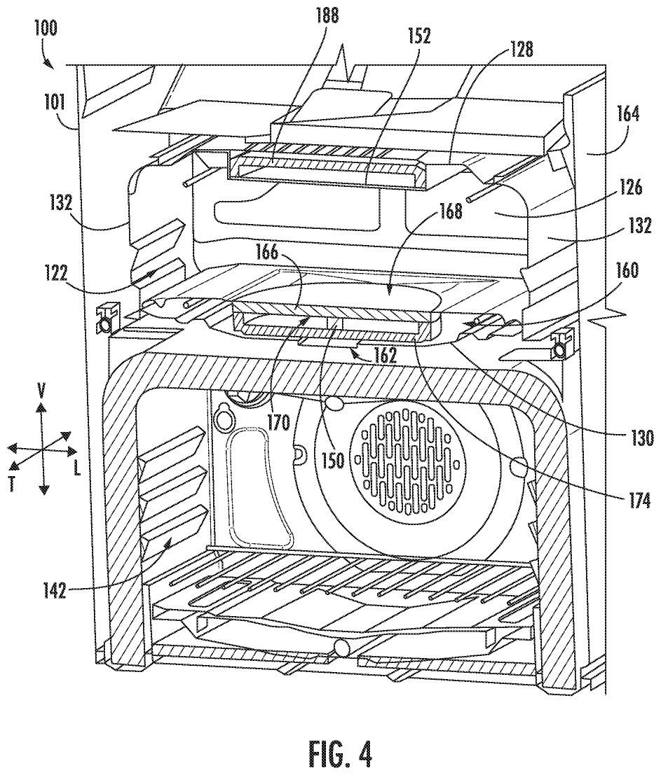

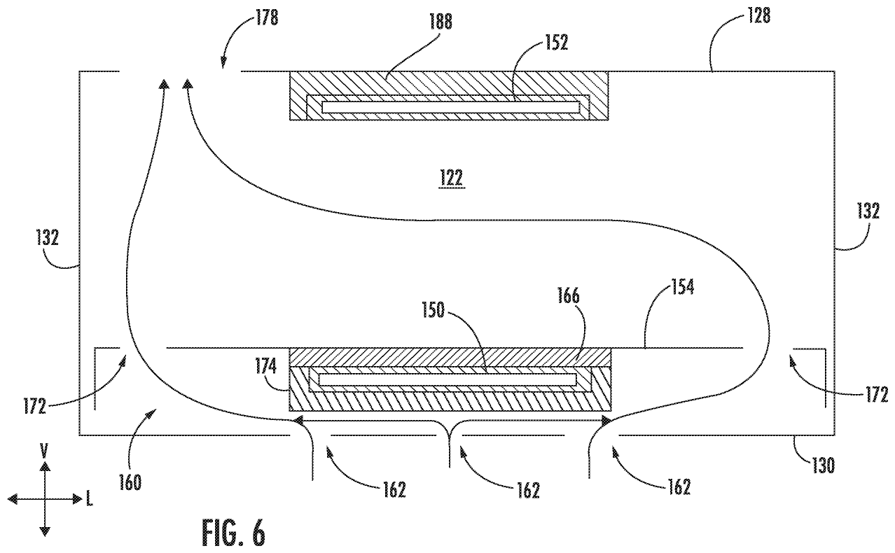

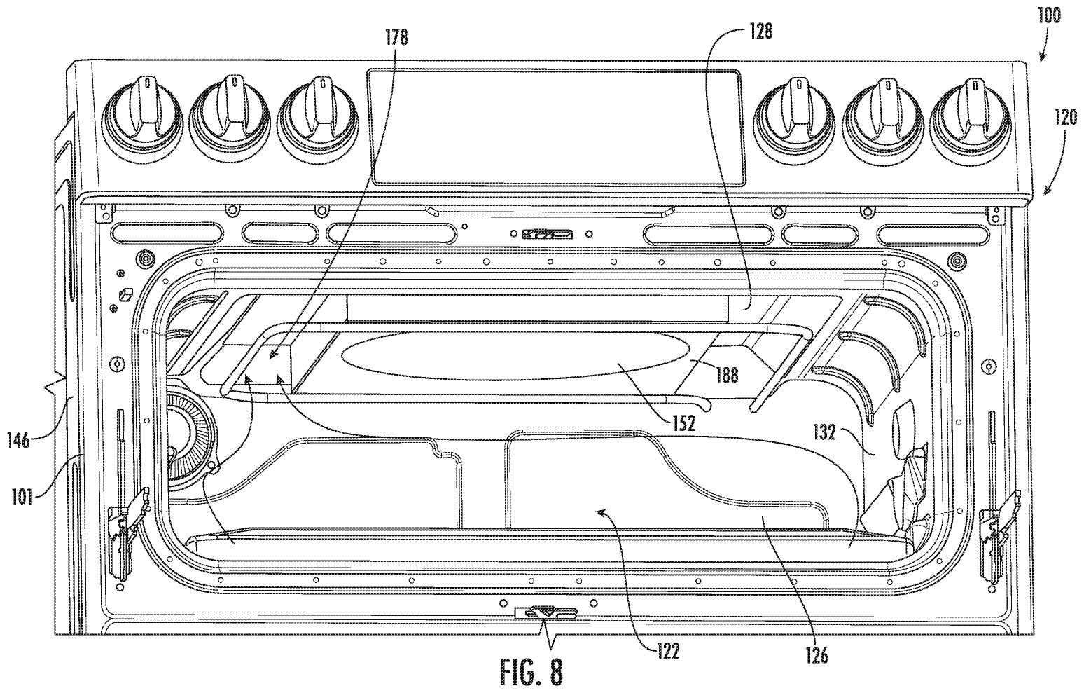

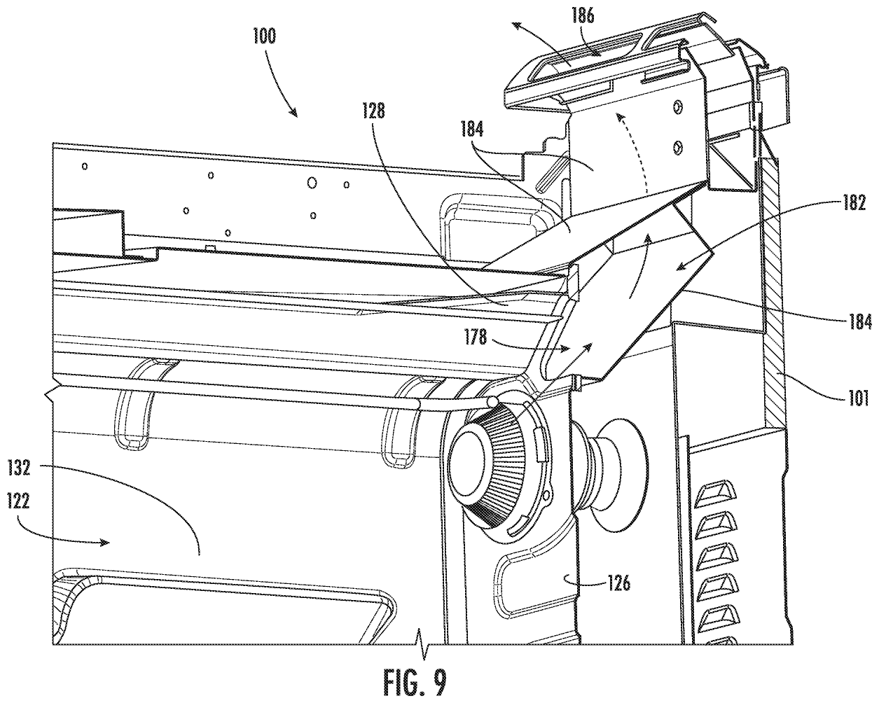

Turning now to FIGS. 2 through 9, various views are provided illustrating, in particular, upper cooking chamber 122 of upper oven 120. As shown, upper cooking chamber 122 is generally defined by a back wall 126, a top wall 128 and a bottom wall 130 spaced from top wall 128 along the vertical direction V by opposing side walls 132 (e.g., a first wall and a second wall). In some embodiments opposing side walls 132 include embossed ribs 134 such that a baking rack containing food items may be slidably received onto embossed ribs 134 and may be moved into and out of upper cooking chamber 122 when door 124 is open. Optionally, such walls 126, 128, 130, 132 may be included within an outer casing 146 of cabinet 101, as is understood.

As shown, upper oven includes one or more heating elements to heat upper cooking chamber 122 (e.g., as directed by controller 110 as part of a cooking operation). For instance, a bottom heating element 150 may be mounted at a bottom portion of upper cooking chamber 122 (e.g., above bottom wall 130). Additionally or alternatively, a top heating element 152 may be mounted at a top portion of upper cooking chamber 122 (e.g., below top wall 128). Bottom heating element 150 and top heating element 152 may be used independently or simultaneously to heat upper cooking chamber 122, perform a baking or broil operation, perform a cleaning cycle, etc.

The heating elements 150, 152 may be provided as any suitable heater for generating heat within upper cooking chamber 122. For instance, either heating element may include an electric heating element (e.g., resistance wire elements, radiant heating element, electric tubular heater or CALROD ®, halogen heating element, etc.). Additionally or alternatively, either heating element may include a gas burner.

As shown, a base panel 154 may be provided within upper cooking chamber 122 (e.g., fixedly mounted or, alternatively, removably mounted). Within upper cooking chamber 122, base panel 154 is generally disposed over the bottom wall 130. In some embodiments, base panel 154 extends laterally between a first end 156 and a second end 158. As shown, the first end 156 may be attached to bottom wall 130 at one lateral side (e.g., proximal to first side wall 132) while second end 158 is attached to bottom wall 130 at the opposite lateral side (e.g., proximal to second side wall 132). Although base panel 154 may be mounted to bottom wall 130, at least a portion of base panel 154 is vertically spaced apart from bottom wall 130. In some embodiments, an enclosed region 160 is defined between base panel 154 and bottom wall 130. For instance, enclosed region 160 may be defined as an air gap between a lower surface 170 of base panel 154 and an upper surface of base panel 154. Base panel 154 may include or be formed from any suitable material (e.g., a first material) for enduring the high-heat environment of upper cooking chamber 122, such as steel.

In certain embodiments, bottom wall 130 defines one or more cavity vents 162. Such cavity vents 162 may be upstream from the enclosed region 160. For instance, cavity vents 162 may be defined below base panel 154 such that air is permitted to flow through bottom wall 130 (e.g., from a surrounding or ambient environment) to enclosed region 160. Optionally, cavity vents 162 may extend along the vertical direction V. Additionally or alternatively, one or more inlets defined by or through cabinet 101 or door upstream of cavity vent 162. During use, ambient air (e.g., outside of oven appliance 100) may be permitted through the inlets and to the enclosed region 160 through the cavity vents 162.

In some embodiments, base panel 154 defines a receiving zone 164 within which a cooking plate 166 is disposed (e.g., fixedly mounted or, alternatively, removably mounted). For instance, cooking plate 166 may be held or embedded within a hole or recess defining receiving zone 164. Optionally, one or more support tabs may be included within receiving zone 164 (e.g., beneath cooking plate 166) to hold cooking plate 166 to base panel 154. Generally, cooking plate 166 may provide an upper cooking surface 168 on which a food item (e.g., bread or pizza) may be received. Cooking plate 166 may be provided as a solid-nonpermeable member or, alternatively, define one or more apertures through which air may pass. In some embodiments, cooking plate 166 includes or is formed from a heat-retaining material, such as clay, stone (e.g., cordierite), ceramic, cast iron, or ceramic-coated carbon steel. In additional or alternative embodiments, cooking plate 166 includes a separate material (e.g., second material) from base panel 154.

Although shown as defining circular upper surface, it is understood that cooking plate 166 may be formed as any suitable shape on which food items may be supported.

Within the enclosed region 160 (e.g., below the receiving zone 164 or cooking plate 166), bottom heating element 150 may be enclosed or covered by base panel 154. Bottom heating element 150 may be disposed below the lower surface 170 of base panel 154. The enclosed region 160 may thus be defined about bottom heating element 150. During use, heat generated at bottom heating element 150 may be directed upward to a lower surface 170 of base panel 154 or cooking plate 166. In some embodiments, bottom heating element 150 is vertically aligned with (e.g., directly beneath) the receiving zone 164 or cooking plate 166. The heat generated at bottom heating element 150 may thus be guided primarily or initially to the underside of the receiving zone 164 or cooking plate 166.

Separate from receiving zone 164, base panel 154 may define one or more oven vents 172. Such oven vents 172 may extend through base panel 154 (e.g., from an upper surface to a lower surface 170). Specifically, oven vents 172 may extend to the enclosed region 160. When assembled, the oven vents 172 may be in fluid communication with (e.g., downstream from) the enclosed region 160. Air may thus pass between the enclosed region 160 and the oven vents 172. During certain operations, air may be routed out of the enclosed region 160 through the oven vents 172. For instance, air may be routed to the surrounding, upper portion of upper cooking chamber 122 or to an ambient environment outside of upper cooking chamber 122. The oven vents 172 may be directed away from the receiving zone 164 or cooking plate 166 (e.g., radially or laterally outward toward side walls 132 or back wall 126). Air from the oven vents 172 may thus be motivated (e.g., by natural or fan-forced convection) into the upper portion of upper cooking chamber 122 from the enclosed region 160 without directly flowing to the upper surface of cooking plate 166—and any food items thereon.

In optional embodiments, multiple oven vents 172 are defined by base panel 154 and spaced apart from each other (e.g., along the lateral direction L). Two or more oven vents 172 may be defined at opposite sides of cooking plate 166. For instance, a first oven vent 172 may be defined at a first lateral side of base panel 154 while a second oven vent 172 is defined at a second lateral side of base panel 154. The first oven vent 172 may be directed outward toward the first side wall 132. The second oven vent 172 may be directed outward toward the second side wall 132. During use, heated air within the enclosed region 160 may thus be evenly distributed through the upper cooking chamber 122 without flowing directly to the receiving zone 164 between the first and second oven vents 172.

In certain embodiments, a bottom insulator plate 174 is provided below the bottom wall 130 along the vertical direction. Specifically, at least a portion of bottom insulator plate 174 is disposed below bottom heating element 150. As an example, bottom insulator plate 174 may be included with or as part of a support dish in which bottom heating element 150 is housed and supported (e.g., within enclosed region 160). Bottom insulator plate 174 may surround bottom heating element 150, while defining a top opening to direct heat from bottom heating element 150 upward (e.g., to receiving zone 164 or cooking plate 166). As an additional or alternative example, bottom insulator plate 174 may include a stand-alone plate vertically aligned below bottom heating element 150 such that bottom heating element 150 is disposed between an upper surface of bottom insulator plate 174 and a lower surface 170 of bottom wall 130. In optional embodiments, bottom insulator plate 174 is disposed above one or more cavity vents 162. For instance, bottom insulator plate 174 may be vertically aligned within cavity vents 162 and downstream therefrom.

Bottom insulator plate 174 may be formed from or include any suitable low thermal conductivity material such as a metal or ceramic (e.g., ceramic fiber) insulation. Additionally or alternatively, bottom insulator plate 174 may be formed from or include any suitable reflector plate or heat shield material (e.g., metal, such as stainless steel, aluminized steel, etc.) such that bottom insulator plate 174 acts as a heat shield redirecting heat upward from bottom insulator plate 174. During use, bottom insulator plate 174 may generally block heat from being transmitted (e.g., downward) from bottom heating element 150. Air (e.g., ambient air) may flow to and across bottom insulator plate 174 from cavity vents 162 within enclosed region 160. Such air may provide further cooling for bottom insulator plate 174. Moreover, at least a portion of the cooling air may flow from bottom insulator plate 174, through enclosed region 160, and from one or more oven vents 172.

Separate from or in addition to the cooling air through enclosed region 160, a front inlet 180 may be defined through a door 124 or outer wall of cabinet 102 to upper cooking chamber 122. For instance, front inlet 180 may be defined as an air gap between door 124 or gasket 114 and a front face of cabinet 102. In certain embodiments, gasket 114 is positioned at the air gap or front inlet 180. During use, front inlet 180 may be upstream from upper cooking chamber 122. Thus, when door 124 is in the closed position, gasket 114 may generally extend across the air gap or front inlet 180 between door 124 and cabinet 102 such that air is permitted to pass from the ambient environment, through front inlet 180, and to upper cooking chamber 122 (e.g., as motivated by natural or forced convection).

One or more temperature sensors 176 may be disposed within the enclosed region 160, for instance, to detect the temperature of bottom heating element 150 or cooking plate 166. Optionally, the temperature sensor 176 may be mounted between the bottom heating element 150 and the cooking plate 166. In some embodiments, a temperature sensor 176 is mounted to cooking plate 166. As an example, the temperature sensor 176 may be disposed on a bottom surface of cooking plate 166 (e.g., via a mechanical fastener, clip, or hook). As an additional or alternative example, the temperature sensor 176 may be held within a recess in cooking plate 166. As an additional or alternative example, the temperature sensor 176 may be embedded within cooking plate 166.

When assembled, the temperature sensor(s) 176 may be operably coupled to controller 110. Moreover, the controller 110 may be configured to control bottom heating element 150 based on the temperature detected at a temperature sensor 176 (e.g., as part of a cooking operation). In some embodiments, a cooking operation initiated by the controller 110 may thus include detecting a temperature of the temperature sensor 176 within the enclosed region 160, and directing heat output from (e.g., a heat setting of) the bottom heating element 150 based on the detected temperature. For instance, a temperature setpoint for cooking plate 166 may be provided to or within the controller 110. While the bottom heating element 150 is active, the controller 110 may detect the temperature at the temperature sensor 176 (e.g., repeatedly) to determine if the temperature setpoint is being met. If not, the controller 110 may increase or decrease the heat setting at the bottom heating element 150 to establish and maintain the temperature at the cooking plate 166 at the temperature setpoint.

In certain embodiments, one or more exhaust openings 178 are defined through the chamber walls. Specifically, an exhaust opening 178 may be defined proximal to top wall 128 (i.e., closer to top wall 128 than bottom wall 130 along the vertical direction V). For instance, at least one chamber wall (e.g., top wall 128 or back wall 126) may define an exhaust opening 178 downstream from the oven vent 172. In some embodiments, exhaust opening 178 is spaced apart from top heating element 152 (e.g., horizontally, such as along the lateral direction L or transverse direction T). Relatively hot air aligned between the heating elements 150, 152 may be drawn away from the region between the heating elements 150, 152, advantageously preventing or reducing the concentration of heat within upper cooking chamber 122 (e.g., even during operations in which upper cooking surface 168 is heated to relatively high temperatures, such as those above 250° or 315° Celsius).

When assembled, the exhaust opening 178 may communicate with the ambient environment about oven appliance 100. In some such embodiments, cabinet 102 defines an exhaust channel 182 that extends from the upstream exhaust opening 178 to a downstream exhaust port 186. As shown, one or more internal guide walls 184 may define exhaust channel 182 outside of upper cooking chamber 122.

In some embodiments, exhaust port 186 is defined, above top wall 128. Additionally or alternatively, exhaust port 186 may be defined proximal to or rearward from back wall 126. By placing exhaust port 186 in a top, back corner of cabinet 102, hot air may be exhausted up and away from both oven appliance 100 and its user. Alternatively, exhaust port 186 may be defined in a rear outer panel of cabinet 102, such that it is not visible to the user, or may be positioned at any other suitable location. Additionally or alternatively, exhaust port 186 may be coupled to an exhaust duct which routes heated air out of the room in which oven appliance 100 is located.

During use, air, gas, or fumes within the upper cooking chamber 122, including at least a portion of air from the enclosed region 160, may exit upper cooking chamber 122 downstream through exhaust opening 178, exhaust channel 182, and exhaust port 186. As is understood, the air through exhaust opening 178 may be motivated by natural convection or by forced convection from an included oven fan (not pictured) that is, for example, mounted within exhaust channel 182.

As noted above, top heating element 152 may be mounted above the bottom heating element 150 to heat upper cooking chamber 122. In certain embodiments, a top insulator plate 188 is mounted between top heating element 152 and top wall 128 (e.g., along the vertical direction V) within upper cooking chamber 122. Specifically, at least a portion of top insulator plate 188 is disposed below bottom heating element 150. As an example, top insulator plate 188 may be included with or as part of a support dish (e.g., open support dish) in which top heating element 152 is housed and supported. Top insulator plate 188 may surround top heating element 152, while defining a bottom opening to direct heat from top heating element 152 downward (e.g., to upper cooking chamber 122 or in the general direction of cooking plate 166). As an additional or alternative example, top insulator plate 188 may include a stand-alone plate vertically aligned above top heating element 152 such that top heating element 152 is disposed between a bottom surface of top insulator plate 188 and upper cooking chamber 122. Optionally, top insulator plate 188 may form an open cavity such that heat may flow directly downward from top heating element 152 to a lower portion of upper cooking chamber 122.

Top insulator plate 188 may be formed from or include any suitable low thermal conductivity material such as a metal or ceramic (e.g., ceramic fiber) insulation. Additionally or alternatively, top insulator plate 188 may be formed from or include any suitable reflector plate or heat shield material (e.g., metal, such as stainless steel, aluminized steel, etc.) such that top insulator plate 188 acts as a heat shield redirecting heat downward from top heating element 152. During use, top insulator plate 188 may generally block heat from being transmitted (e.g., downward) from bottom heating element 150. Air may flow to and across top insulator plate 188 from upper cooking chamber 122 and to exhaust opening 178.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a vertical, a lateral, and a transverse direction, the oven appliance comprising:
a cabinet;
a plurality of chamber walls mounted within the cabinet, the plurality of chamber walls defining an oven chamber, the plurality of chamber walls comprising a back wall, a top wall, a first side wall, a second side wall, and a bottom wall;
a cooking surface defined in the oven chamber between the bottom wall and the top wall; and
a bottom heating element mounted above the bottom wall to heat the cooking surface within the oven chamber,
wherein the chamber walls define a cavity vent and an exhaust opening, the cavity vent being defined upstream from the oven chamber below the bottom heating element, the exhaust outlet being defined downstream from the oven chamber and proximal to the top wall to direct air from the cabinet.

2. The oven appliance of claim 1, further comprising:
a top heating element mounted above the bottom heating element to heat the oven chamber; and
a top insulator plate mounted between the top heating element and the top wall within the oven chamber.

3. The oven appliance of claim 1, further comprising:
a door rotatably mounted on the cabinet to selectively restrict access to the oven chamber in a closed position, wherein a front inlet, upstream from the oven chamber, is defined between the cabinet and the door in the closed position.

4. The oven appliance of claim 1, further comprising:
a base panel disposed over the bottom heating element, the base panel defining an oven vent and a receiving zone spaced apart from the oven vent, the base panel further defining an enclosed region with the bottom wall about the bottom heating element.

5. The oven appliance of claim 4, further comprising:
a bottom insulator plate disposed between the bottom heating element and the bottom wall along the vertical direction.

6. The oven appliance of claim 4, wherein the oven vent is a first oven vent defined at a first lateral side of the base panel, and wherein the base panel defines a second oven vent at the second lateral side, the first and second oven vents being spaced apart from each other at opposite sides of the cooking surface.

7. The oven appliance of claim 4, further comprising:
a cooking plate disposed on the base panel within the receiving zone, the cooking plate defining the cooking surface.

8. The oven appliance of claim 4, further comprising:
a temperature sensor disposed within the enclosed region.

9. The oven appliance of claim 8, further comprising:
a controller operably coupled to the temperature sensor and the bottom heating element, the controller being configured to initiate a cooking operation comprising detecting a temperature of the temperature sensor within the enclosed region, and
directing heat output from the bottom heating element based on the detected temperature.

10. An oven appliance defining a vertical, a lateral, and a transverse direction, the oven appliance comprising:
a cabinet;
a plurality of chamber walls mounted within the cabinet, the plurality of chamber walls defining an oven chamber, the plurality of chamber walls comprising a back wall, a top wall, a first side wall, a second side wall, and a bottom wall;
a cooking surface defined in the oven chamber between the bottom wall and the top wall;
a bottom heating element mounted above the bottom wall to heat the cooking surface within the oven chamber; and
a top heating element mounted above the bottom heating element to heat the oven chamber,
wherein the chamber walls define a cavity vent and an exhaust opening, the cavity vent being defined upstream from the oven chamber below the bottom heating element, the exhaust outlet being defined downstream from the oven chamber and spaced apart from the top heating element to direct air from the cabinet.

11. The oven appliance of claim 10, further comprising:
a top insulator plate mounted between the top heating element and the top wall within the oven chamber.

12. The oven appliance of claim 10, further comprising:
a door rotatably mounted on the cabinet to selectively restrict access to the oven chamber in a closed position, wherein a front inlet, upstream from the oven chamber, is defined between the cabinet and the door in the closed position.

13. The oven appliance of claim 10, further comprising:
a base panel disposed over the bottom heating element, the base panel defining an oven vent and a receiving zone spaced apart from the oven vent, the base panel further defining an enclosed region with the bottom wall about the bottom heating element.

14. The oven appliance of claim 13, further comprising:
a bottom insulator plate disposed between the bottom heating element and the bottom wall along the vertical direction.

15. The oven appliance of claim 13, wherein the oven vent is a first oven vent defined at a first lateral side of the base panel, and wherein the base panel defines a second oven vent at the second lateral side, the first and second oven vents being spaced apart from each other at opposite sides of the cooking surface.

16. The oven appliance of claim 13, further comprising:
a cooking plate disposed on the base panel within the receiving zone, the cooking plate defining the cooking surface.

17. The oven appliance of claim 13, further comprising:
a temperature sensor disposed within the enclosed region.

18. The oven appliance of claim 17, further comprising:
a controller operably coupled to the temperature sensor and the bottom heating element, the controller being configured to initiate a cooking operation comprising
detecting a temperature of the temperature sensor within the enclosed region, and
directing heat output from the bottom heating element based on the detected temperature.

19. An oven appliance defining a vertical, a lateral, and a transverse direction, the oven appliance comprising:
a cabinet;
a plurality of chamber walls mounted within the cabinet, the plurality of chamber walls defining an oven chamber, the plurality of chamber walls comprising a back wall, a top wall, a first side wall, a second side wall, and a bottom wall;
a cooking surface defined in the oven chamber between the bottom wall and the top wall;
a bottom heating element mounted above the bottom wall to heat the cooking surface within the oven chamber; and
a bottom insulator plate disposed between the bottom heating element and the bottom wall along the vertical direction;
wherein the chamber walls define a cavity vent and an exhaust opening, the cavity vent being defined upstream from the oven chamber, the exhaust outlet being defined downstream from the oven chamber and proximal to the top wall to direct air from the cabinet.
